(19) United States
(12) Patent Application Publication
(10) Pub. No.: US 2020/0256453 A1
(43) Pub. Date: Aug. 13, 2020

(54) Wheel Case and Vibrating Screen Device

(71) Applicant: McLanahan Corporation, Hollidaysburg, PA (US)

(72) Inventors: Steven A. Reicks, Solon, IA (US); Gregory A. Young, Cedar Rapids, IA (US)

(21) Appl. No.: 16/784,558

(22) Filed: Feb. 7, 2020

Related U.S. Application Data
(60) Provisional application No. 62/802,729, filed on Feb. 8, 2019.

(51) Int. Cl. F16H 57/04

(52) U.S. Cl. CPC F16H 57/0421; F16C 33/10

(57) ABSTRACT

A wheel case for a vibrating device for vibrating aggregate material includes a housing configured to contain a quantity of lubricating oil and a wheel positioned in the housing and mounted to a shaft of the vibrating device. The wheel includes: an inwardly facing side; an outwardly facing side; an eccentric weight mounted to the inwardly facing side or the outwardly facing side; and a plurality of bearings positioned in an annular bearing channel configured to permit the wheel to rotate about a spindle of the shaft. The wheel case also includes a dam mounted to the wheel at least partially covering the annular bearing channel, positioned such that the lubricating oil collects in the annular bearing channel during rotation of the wheel, and such that the collected lubricating oil remains in the annular bearing channel when rotation of the wheel ceases.

### CROSS-REFERENCE TO RELATED APPLICATION

This application claims the benefit of U.S. Provisional Patent Application No. 62/802,729, filed Feb. 8, 2019, the disclosure of which is hereby incorporated by reference in its entirety.

### BACKGROUND OF THE INVENTION

### Field of the Invention

The present invention relates to vibrating devices, such as vibrating screens for classifying aggregate, and vibrating feeders for feeding aggregate to crushing and processing devices, and, specifically, to lubrication systems for lubricating and cooling rotating components disposed inside of a wheel case of the vibrating device.

### Description of Related Art

Vibrating screen devices and vibrating feeder devices are used for classifying aggregate. A typical vibrating screen device includes one or more classifying screen(s) mounted to a frame. The frame can be supported on one or more springs or shocks for isolating the vibrating screen and frame from other supporting structures. At or near a center of the device is an eccentrically weighted shaft unit, typically having one, two, three, or more rotating and eccentrically weighted shafts. On a multi-shaft unit, the shafts may be counter-rotating such that the eccentric weights are oriented in the same direction twice each revolution. This arrangement of the eccentric weights causes the screen(s) to vibrate, which aids the classifying effects of the vibrating screen device. On a vibrating feeder, a similar shaft unit vibrates a feed trough or chute, which throws the aggregate contained in the trough in a desired direction. An exemplary vibrating screen device is described in U.S. Pat. No. 4,340,469 entitled “Vibrating Screen Apparatus,” which is incorporated by reference herein in its entirety. Other exemplary vibrating screen devices are described in U.S. Pat. No. 6,161,650, entitled “Lubricating System for a Vibratory Apparatus,” and U.S. Pat. No. 6,347,708, entitled “Wheel Case for a Vibratory Apparatus,” which are also incorporated by reference herein in their entireties.

In typical vibrating screen devices including three or more shafts, ends of the rotating shafts are supported by bearings and are operatively coupled to an external driving device, such as a drive motor. Each of the shafts includes a gear or drive wheel. The eccentric weights are typically attached directly to the drive wheels. The bearings and the gear teeth on the drive wheels require constant lubrication. In order to provide suitable lubrication, the wheel and bearings can be disposed within a housing or wheel case containing a quantity of oil or another suitable lubricant. For example, a wheel case can be provided on each side of the vibrating device and bolted to an adjacent sidewall or a portion of the frame of the vibrating device.

During use of the vibrating device, the wheel(s) and bearing(s) rotate through lubricating oil in the housing or wheel case. Movement of the wheel(s) and bearing(s) distributes the lubricating oil through the wheel case to provide sufficient lubrication for device components. In some vibrating devices, the wheel case is configured so that the oil level inside the wheel case is near the lowest point of travel of the wheel. The oil level is maintained such that the eccentric weights attached to the rotating wheel dip into the oil causing the oil to splash upwardly onto the bearings. The gear teeth on the outer circumference of the wheel, which has a swing diameter slightly greater than the swing diameter of the rotating weights, can also dip into the oil to lubricate outer portions of the wheel.

Some exemplary vibrating devices also include structures, such as walls, baffles, or fins, in the wheel case or housing to improve distribution of lubricating oil. For example, the '650 patent discloses that one or more baffles can be positioned extending into the housing from a bottom or side of the wheel case. The baffles define lubricating oil reservoir(s) which collect lubricating oil as the wheel and shaft rotate. The reservoir(s) provide lubricating oil to upper portions of the wheel and/or shaft, above the oil level thereby improving oil distribution through the wheel case.

### SUMMARY OF THE INVENTION

New designs for wheel case arrangements and lubrication systems, which improve flow and/or distribution of lubricating oil in the wheel case, would be useful for protecting components of vibrating devices during use. Accordingly, the present invention is directed to an improved wheel case including structures for enhancing flow of lubricating oil to bearings. In particular, in some aspects, the present disclosure is directed to structures arranged to ensure that lubricating oil is provided to the bearings during startup of the vibrating device. Improving distribution of lubricating oil during device startup can extend the useful life of the rotating components housed within the wheel case by ensuring that rotating components of the wheel case are exposed to lubricating oil at all times, including during initial operation or startup of the vibrating device.

According to an aspect of the disclosure, a wheel case for a vibrating device for vibrating aggregate material includes a housing configured to contain a quantity of lubricating oil and at least one wheel positioned in the housing and mounted to a shaft of the vibrating device. The at least one wheel includes: an inwardly facing side; an outwardly facing side; at least one eccentric weight mounted to the inwardly facing side or the outwardly facing side; and a plurality of bearings positioned in an annular bearing channel configured to permit the at least one wheel to rotate about a spindle of the shaft. The at least one wheel is arranged such that during rotation of the at least one wheel, the lubricating oil is distributed through the housing to lubricate the at least one wheel, bearings, and/or shaft. The wheel case also includes a dam mounted on a side of the at least one wheel at least partially covering the annular bearing channel, positioned such that the lubricating oil collects in the annular bearing channel during rotation of the at least one wheel, and such that the collected lubricating oil remains in the annular bearing channel when rotation of the wheel ceases.

According to another aspect of the disclosure, a vibrating device for vibrating aggregate material includes a frame; at least one rotating shaft rotatably mounted to the frame, the at least one shaft being configured to be rotated by an external drive device; and a wheel case enclosing at least a portion of the at least one shaft. The wheel case includes a housing configured to contain a quantity of lubricating oil; and at least one wheel positioned in the housing and mounted to the at least one shaft of the vibrating device. The at least one wheel includes: an inwardly facing side; an outwardly facing side; at least one eccentric weight mounted to the inwardly facing side or the outwardly facing side; and a plurality of bearings positioned in an annular bearing channel configured to permit the at least one wheel to rotate about a spindle of the shaft. The at least one wheel is arranged such that during rotation of the at least one wheel, the lubricating oil is distributed through the housing to lubricate the at least one wheel, bearings, and/or shaft. The wheel case also includes a dam mounted on a side of the at least one wheel at least partially covering the annular bearing channel, positioned such that the lubricating oil collects in the annular bearing channel during rotation of the at least one wheel, and such that the collected lubricating oil remains in the annular bearing channel when rotation of the wheel ceases.

Examples of the present invention will now be described in the following numbered clauses:

Clause 1: A wheel case for a vibrating device for vibrating aggregate material, the wheel case comprising: a housing configured to contain a quantity of lubricating oil; at least one wheel positioned in the housing and mounted to a shaft of the vibrating device, the at least one wheel comprising: an inwardly facing side; an outwardly facing side; at least one eccentric weight mounted to the inwardly facing side or the outwardly facing side; and a plurality of bearings positioned in an annular bearing channel configured to permit the at least one wheel to rotate about a spindle of the shaft, wherein the at least one wheel is arranged such that during rotation of the at least one wheel, the lubricating oil is distributed through the housing to lubricate the at least one wheel, bearings, and/or shaft; and a dam mounted on a side of the at least one wheel at least partially covering the annular bearing channel, positioned such that the lubricating oil collects in the annular bearing channel during rotation of the at least one wheel, and such that the collected lubricating oil remains in the annular bearing channel when rotation of the wheel ceases.

Clause 2: The wheel case of clause 1, wherein the collected lubricating oil in the annular bearing channel is available to lubricate the at least one wheel and/or the plurality of bearings when rotation of the at least one wheel resumes.

Clause 3: The wheel case of clause 2, further comprising an external drive device configured to rotate the at least one shaft of the vibrating device, wherein rotation of the at least one wheel ceases when the external drive device is deactivated, and wherein rotation of the at least one wheel resumes upon reactivation of the external drive device.

Clause 4: The wheel case of any of clauses 1-3, wherein, during rotation of the at least one wheel, at least a portion of an outer diameter of the at least one wheel and/or the at least one eccentric weight contacts a portion of the lubricating oil collected in a bottom portion of the housing, causing the lubricating oil to be distributed through the housing.

Clause 5: The wheel case of any of clauses 1-4, wherein when rotation of the at least one wheel ceases, a level of the lubricating oil in the annular bearing channel is at least partially defined by a height of a portion of the dam covering the annular bearing channel.

Clause 6: The wheel case of any of clauses 1-5, wherein the at least one wheel comprises a hub operatively connecting the at least one shaft to other portions of the at least one wheel, the hub being adapted to distribute the lubricating oil to the plurality of bearings as the at least one wheel rotates about the plurality of bearings.

Clause 7: The wheel case of clause 6, wherein the hub is positioned on the outwardly facing side of the at least one wheel.

Clause 8: The wheel case of clause 6 or clause 7, wherein the hub comprises at least one aperture extending through the hub, from an outwardly facing side to an inwardly facing side thereof, and wherein the at least one aperture is aligned with the annular bearing channel.

Clause 9: The wheel case of clause 6 or clause 7, wherein the hub comprises a plurality of circumferentially positioned apertures extending through the hub, from an outwardly facing side to an inwardly facing side thereof.

Clause 10: The wheel case of clause 9, wherein the dam is mounted to the inwardly facing side of the at least one wheel opposite at least one of the plurality of apertures of the hub, and wherein the at least one aperture positioned opposite to the dam has a smaller area than other apertures of the plurality of apertures which are not opposite to the dam.

Clause 11: The wheel case of any of clauses 6-10, wherein the hub comprises a circumferential outer edge and a peripheral sidewall spaced radially inward from the outer edge, and wherein an inwardly facing portion of the sidewall defines an oil receiving pocket aligned with and adapted to distribute the lubricating oil into the annular bearing channel.

Clause 12: The wheel case of any of clauses 1-11, wherein the dam comprises a plate comprising an outwardly facing side and an inwardly facing side, and wherein the outwardly facing side of the plate is mounted to the inwardly facing side of the wheel.

Clause 13: The wheel case of clause 12, wherein the plate further comprise an arcuate inner edge, an arcuate outer edge, and radial edges extending there between.

Clause 14: The wheel case of clause 13, wherein the arcuate inner edge of the plate defines an arc of less than about 120 degrees, such that the plate covers less than about one third of the annular bearing channel.

Clause 15: The wheel case of clause 13 or clause 14, wherein the arcuate outer edge of the plate contacts an edge of the at least one eccentric weight mounted to the at least one wheel.

Clause 16: The wheel case of clause 15, wherein the at least one eccentric weight comprises an arcuate plate mounted to the inwardly facing side of the at least one wheel.

Clause 17: The wheel case of any of clauses 1-16, wherein the vibrating device comprises at least a first shaft, a second shaft, and a third shaft, and wherein the wheel case comprises at least a first wheel mounted to the first shaft, a second wheel mounted to the second shaft, and a third wheel mounted to the third shaft.

Clause 18: The wheel case of any of clauses 1-17, wherein the at least one wheel comprises gear teeth extending about a periphery of the at least one wheel arranged to transfer rotation of the at least one wheel to another wheel at least partially enclosed in the wheel case.

Clause 19: The wheel case of any of clauses 1-11, wherein the dam is integrally formed with the at least one eccentric weight.

Clause 20: A vibrating device for vibrating aggregate material, the device comprising: a frame; at least one rotating shaft rotatably mounted to the frame, the at least one shaft being configured to be rotated by an external drive device; and a wheel case enclosing at least a portion of the at least one shaft, the wheel case comprising: a housing configured to contain a quantity of lubricating oil; at least one wheel positioned in the housing and mounted to the at least one shaft of the vibrating device, the at least one wheel comprising: an inwardly facing side; an outwardly facing side; at least one eccentric weight mounted to the inwardly facing side or the outwardly facing side; and a plurality of bearings positioned in an annular bearing channel configured to permit the at least one wheel to rotate about a spindle of the shaft, wherein the at least one wheel is arranged such that during rotation of the at least one wheel, the lubricating oil is distributed through the housing to lubricate the at least one wheel, bearings, and/or shaft; and a dam mounted on a side of the at least one wheel at least partially covering the annular bearing channel, positioned such that the lubricating oil collects in the annular bearing channel during rotation of the at least one wheel, and such that the collected lubricating oil remains in the annular bearing channel when rotation of the wheel ceases.

Clause 21: The vibrating device of clause 20, wherein the wheel case comprises a first wheel, a second wheel, and a third wheel, and wherein the vibrating device comprises a first shaft mounted to the first wheel, a second shaft mounted to the second wheel, and a third shaft mounted to the third wheel.

Clause 22: The vibrating device of clause 21, wherein each of the wheels comprise gear teeth extending about a periphery of the wheels arranged such that rotation of one of the shafts is transferred to each of the wheels through engagement between gear teeth of the wheels.

Clause 23: The vibrating device of clause 21 or clause 22, wherein the first, second, and third wheels are configured to come to rest at any of a plurality of timing positions, and wherein the dam of each of the wheels is positioned such that the dam retains lubricating oil in the annular bearing channel of each wheel, when the wheels are in any of the plurality of timing positions.

Clause 24: The vibrating device of clause 23, wherein the first, second, and third wheels are configured to come to rest in at least seven timing positions.

Clause 25: The vibrating device of any of clauses 21-24, wherein the frame comprises a deck configured to retain a classification screen, and wherein rotation of the at least one shaft and the at least one wheel vibrates the deck and the classification screen retained by the deck.

### BRIEF DESCRIPTION OF THE DRAWINGS

Some of the advantages and features of the preferred embodiments of the invention have been summarized hereinabove. These embodiments, along with other potential embodiments of the device, will become apparent to those skilled in the art when referencing the following drawings in conjunction with the detailed descriptions as they relate to the figures:

FIG. 1 is a front view of a vibrating screen device and support structure having a three shaft sealed wheel case, according to an aspect of the disclosure;

FIG. 2 is a top view of the vibrating screen device of FIG. 1 with the wheel case removed;

FIG. 3A is a cross-sectional view of the vibrating screen device of FIG. 2, taken along line 3A-3A and including the wheel case;

FIG. 3B is a detailed view of the cross-sectional view of detail 3B in FIG. 3A;

FIG. 4A is an exploded perspective view of a wheel of the vibrating screen device of FIG. 1;

FIG. 4B is a perspective view of another wheel of the vibrating screen device of FIG. 1;

FIG. 5A is a front view of the wheel of FIG. 4A, showing an outwardly facing side of the wheel;

FIG. 5B is a cross-sectional view of the vibrating screen device taken along line 5B-5B in FIG. 2, showing an inwardly facing side of the wheel of FIG. 4A;

FIG. 5C is a cross-sectional view of the vibrating screen device taken along line 5C-5C in FIG. 2, showing an inwardly facing side of the wheel of FIG. 4B;

FIG. 5D is a rear view of the vibrating screen device of FIG. 2, showing an outwardly facing side of the wheel of FIG. 4B;

FIG. 6 is a front view of the vibrating screen device of FIG. 1, showing the outwardly facing sides of three wheels of the wheel case in an installation position;

FIG. 7A is a front view of outwardly facing sides of the three wheels at a rest position with 30° timing;

FIG. 7B is a front view of outwardly facing sides of the three wheels at a rest position with 60° timing;

FIG. 8 is a detailed cross sectional view of a portion of another exemplary wheel case, according to an aspect of the present disclosure; and

FIG. 9 is a cross-sectional view showing an inwardly facing side of a wheel of the wheel case of FIG. 8.

### DESCRIPTION OF THE INVENTION

The drawings generally show preferred embodiments of a vibrating screen device and wheel case. While the descriptions present various examples of the vibrating screen device, it should not be interpreted in any way as limiting the invention. Furthermore, modifications, concepts, and applications of the embodiments of the invention are to be interpreted by those skilled in the art as being encompassed, but not limited to, the illustrations and descriptions herein. Additionally, the following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. The terms “inner” or “inward” refer to a direction toward a center of the apparatus or device. “Outer” or “outward” refers to a direction away from a center and toward an exterior of the apparatus or device. However, it is to be understood that the invention may assume various alternative variations and step sequences, except where expressly specified to the contrary. It is also to be understood that the specific devices and processes illustrated in the attached drawings and described in the following specification are simply exemplary embodiments of the invention. Hence, specific dimensions and other physical characteristics related to the embodiments disclosed herein are not to be considered as limiting. For the purpose of facilitating an understanding of the invention, the accompanying drawings and descriptions illustrate preferred embodiments thereof, from which the invention, various embodiments of its structures, construction and method of operation, and many advantages may be understood and appreciated.

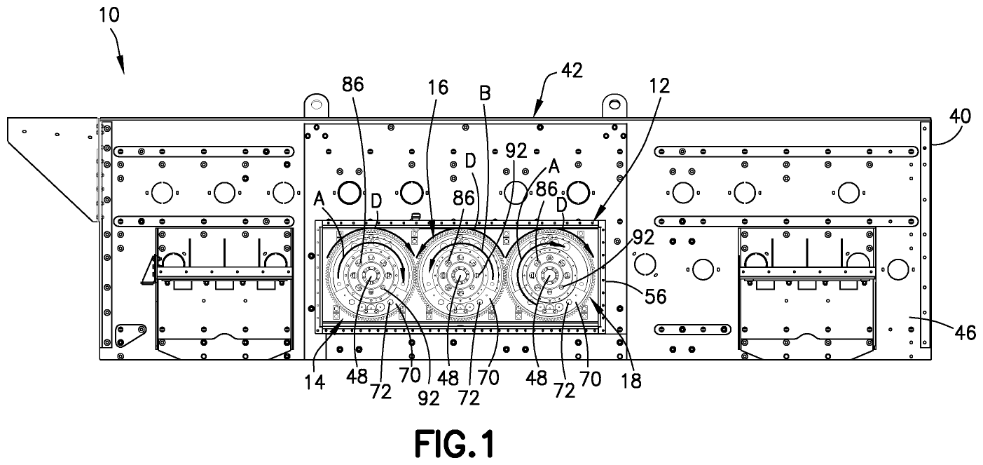

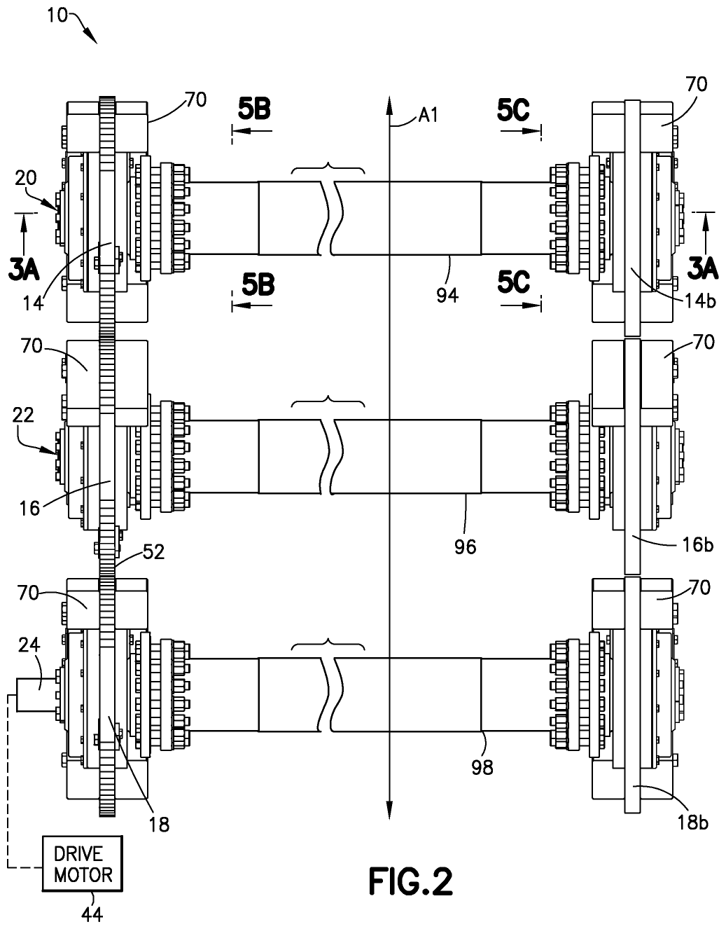

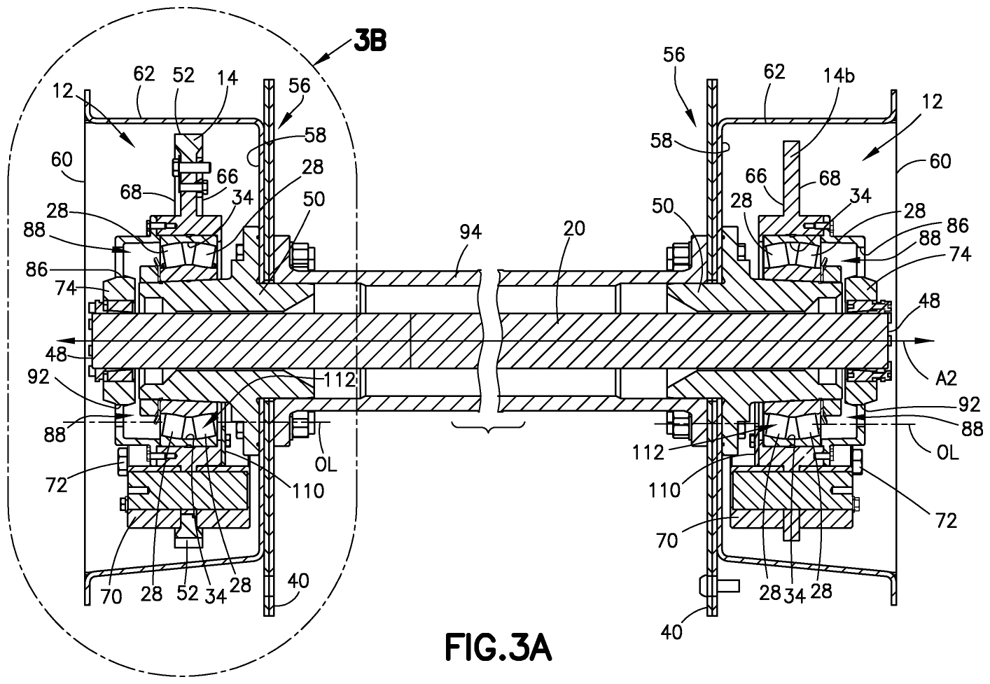

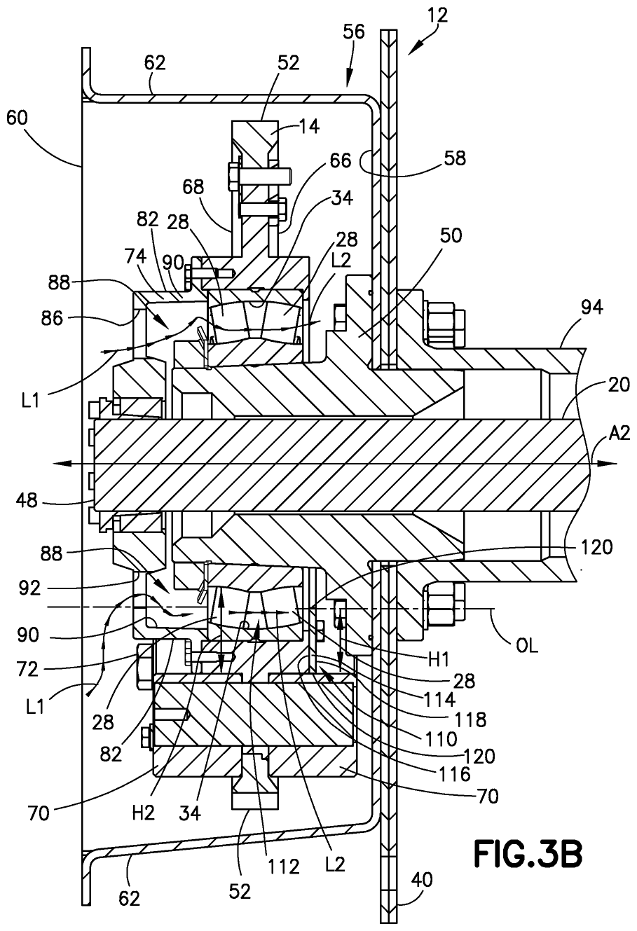

Referring to the figures, the present disclosure generally relates to vibrating devices, such as a vibrating screen device 10 shown in FIG. 1, including one or more wheel cases 12 at least partially enclosing one or more rotating wheels 14, 16, 18 and bearings 28 (shown in FIGS. 3A and 3B). In some examples, the vibrating screen device 10 can be substantially symmetrical about a central axis A1 (shown in FIG. 2), and can include wheels 14, 16, 18 on a first side of the vibrating screen device 10 and wheels 14b, 16b, 18b on an opposing second side of the vibrating screen device 10. As described in further detail herein, wheels 14, 16, 18 are similar in size and shape to opposing wheels 14b, 16b, 18b in most aspects, except that the wheels 14, 16, 18 include interconnecting gears (e.g., gear teeth 52). The opposing wheels 14b, 16b, 18b do not include gears. The vibrating screen device 10 is configured to separate and classify aggregate materials according to size. As will be appreciated by those skilled in the art, the wheel cases 12 disclosed herein can also be used on other devices, such as vibrating trough feeders, as well as other devices benefiting from the vibrating and lubrication features discussed below.

The present disclosure is also directed to structures and methods for lubricating and cooling rotating components of the vibrating screen device 10 by, for example, collecting and distributing lubricating oil to rotating wheels, shafts, and/or bearings of the vibrating screen device 10. Beneficially, ensuring that lubricating oil is available prevents damage to device components, which can occur when components are used without sufficient lubrication. In some aspects, the present disclosure is directed to wheel cases 12 at least partially enclosing shafts 20, 22, 24 of the vibrating screen device 10, and including a housing 56 for collecting the lubricating oil. As described in further detail herein, as the shafts 20, 22, 24 and wheels 14, 16, 18 connected thereto rotate, portions of the wheels 14, 16, 18 pass through the lubricating oil agitating the oil and causing the oil to splash and distribute throughout the interior of the wheel case 12. The shafts 20, 22, 24 can be enclosed in shaft tubes 94, 96, 98 covering at least a portion of the shafts 20, 22, 24. For example, the shaft tubes 94, 96, 98 can be cylindrical structures extending between the wheels 14, 14b, 16, 16b, 18, 18b, as shown in FIG. 2.

One problem with conventional vibrating screen devices is that when rotation of the shaft(s) and wheel(s) ceases, the lubricating oil settles in the bottom of the wheel case, meaning that portions of the wheel(s), bearing(s), and shaft(s) above a level of the settled oil are not lubricated and can become dry. In such conventional vibrating screen devices, there is often a substantial lag time between initial start-up of the vibrating screen device and a time when the oil is warm enough and sufficiently agitated to be properly distributed by the rotating wheel(s) and bearing(s). In particular, since the lubricating oil collects in the bottom of the wheel case when rotation of the wheel ceases, the bearings and portions of the wheel may not be lubricated when the vibrating device is first activated. This lag time is exaggerated by low ambient temperatures when the oil is significantly more viscous, meaning that it is less likely to be agitated or splash as the wheel(s) begin to rotate. During this lag time, the bearings can be starved of lubricant, which can cause damage to the bearings and can lead to premature bearing failure. The vibrating screen device 10 of the present disclosure is configured to address this problem by including an oil dam 110 (shown in FIGS. 3A-7B) configured to trap or maintain lubricating oil in proximity to the rotating components of the wheel case 12 after rotation of the wheel(s) 14, 16, 18 and shaft(s) 20, 22, 24 ceases so that the lubricating oil is present upon initial startup.

With reference again to FIG. 1, the vibrating screen device 10 includes a frame 40 supporting a deck 42 to which is mounted one or more classifying screens (not shown) configured to permit aggregate of selected sizes to pass through the screen(s) as the screen(s) are vibrated by an external drive device, such as a drive motor 44 (shown in FIG. 2). The vibrating screen device 10 further includes opposing sidewalls 46 secured to the frame 40. The shafts 20, 22, 24 are rotatably mounted to the frame 40 and extend between the sidewalls 46 thereof. The shafts 20, 22, 24 are at least partially enclosed by the wheel case 12 mounted to the frame 40. In some examples, the vibrating screen device 10 includes three shafts, such as a first shaft 20 enclosed in tube 94, a second shaft 22 enclosed in tube 96, and a third shaft 24 enclosed in tube 98, and six wheels. As shown in FIG. 2, the wheels 14, 16, 18 are adjacent to first ends of the shafts 20, 22, 24 and the wheels 14b, 16b, 18b are adjacent to second ends of the shafts 20, 22, 24.

In some examples, the first shaft 20 and the third shaft 24 can be configured to rotate in a clockwise direction (shown by arrow A in FIG. 1), while the middle or second shaft 22 can be configured to rotate in a counterclockwise direction (shown by arrow B in FIG. 1). At least one of the shafts, for example the third shaft 24, includes a portion extending out of the wheel case 12, such as through a sealed aperture (not shown) of the wheel case 12 for operative engagement with the drive motor 44. The wheels 14, 16, 18 can be connected by gear teeth 52 such that rotation of the third shaft 24 is transferred to the first wheel 20 and the second wheel 22 through the engagement between the gear teeth 52 of the wheels 14, 16, 18. As noted previously, the wheels 14, 16, 18 include the gear teeth 52. The opposing wheels 14b, 16b, 18b do not include gear teeth.

A cross-sectional view of the wheel case 12 and the first shaft 20 is shown in FIGS. 3A and 3B. The second shaft 22 and the third shaft 24 are similar in size and shape to the first shaft 20, and include the components of the first shaft 20, as described herein. The shaft 20 shown in FIGS. 3A and 3B can be substantially symmetrical, meaning that opposing sides of shaft 20 include substantially the same elements in the same configuration. For example, the wheel 14 on one end of the shaft 20 can be similar in size, shape, and construction to the opposing wheel 14b on the opposite side of the shaft 20, except that the first wheel 14 includes gear teeth 52, which are not present on the opposing wheel 14b.

As shown in FIGS. 3A and 3B, the wheel case 12 of the vibrating screen device 10 includes a housing 56 having a base wall 58, a cover wall 60, and sidewalls 62 extending between the base wall 58 and the cover wall 60. The cover wall 60 is preferably removable in order to gain access to the various components housed within the wheel case 12. The housing 56 can be secured to the frame 40 by suitable fasteners, such as bolts or screws.

The first wheel 14 is at least partially disposed in the wheel case 12. Other wheels, such as the second wheel 16 and the third wheel 18, may also be disposed in the wheel case 12 or in separate wheel cases 12. The wheel 14 can include an inwardly facing side 66, an outwardly facing side 68, and at least one eccentric weight 70 mounted to at least one of the sides 66, 68 of the wheel 14. For example, the eccentric weight 70 can be attached to one or both sides 66, 68 of the wheel 14 using a suitable fastener, such as bolts 72 or screws. As the wheel 14 rotates, the weights 70 are configured to follow a circular path generally indicated by arrow A (shown in FIG. 1), which is spaced radially inward from and concentric with the wheel path shown by arrow D of gear teeth 52. The eccentric weights 70 can be an arcuate plate mounted to the inwardly facing side 66 or to the outwardly facing side 68 of the wheel 14.

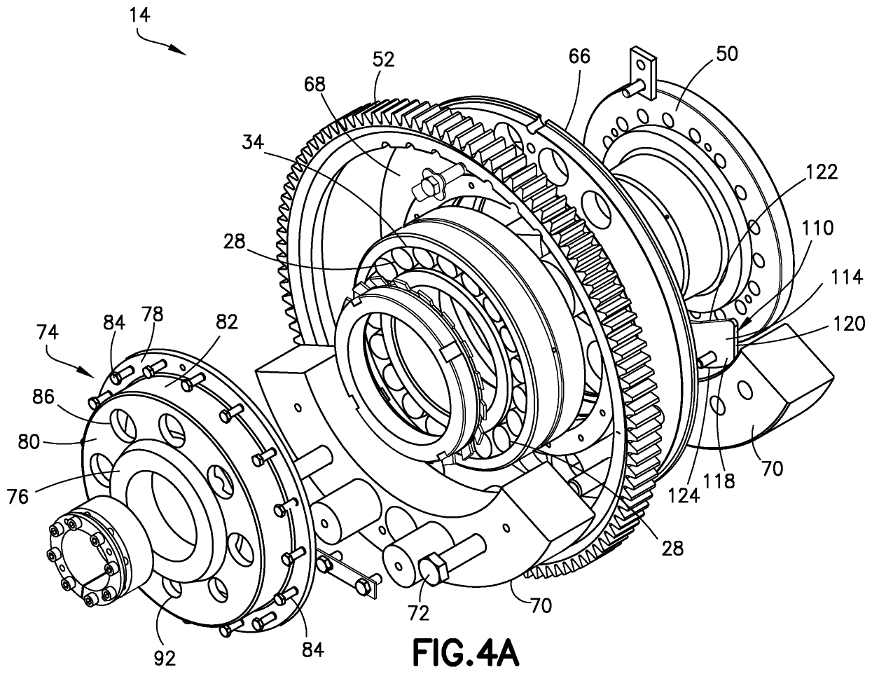

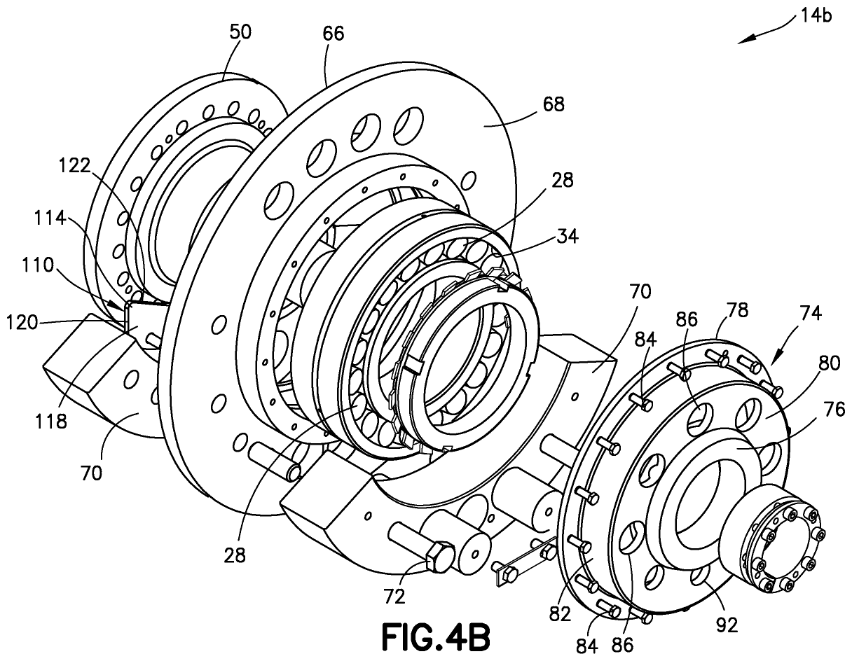

As shown in FIGS. 3A-4B, an end 48 of the first shaft 20 is fixedly connected to a hub 74 of the first wheel 14. A spindle 50 positioned inwardly from the hub 74 is fixedly connected to the housing 56 and includes a central bore, through which the shaft 20 passes. The shaft 20 rotates relative to the spindle 50, while the spindle 50 remains fixed in place. A bearing assembly including the bearings 28 is positioned between the wheel 14 and the spindle 50, which allows the wheel 14 to rotate relative to the spindle 50 over the bearings 28. In some examples, the wheel 14 includes the circumferential gear teeth 52. The wheel 14 is configured such that, as the wheel 14 rotates, the gear teeth 52 and the wheel 14 follows a circular wheel path indicated by the arrow D (shown in FIG. 1).

The wheel case 12 is adapted to contain the lubricating oil for lubricating the wheels 14, 16, 18 and the bearings 28. The lubricating oil is supplied to the bearings 28 on the outer circumference of the first wheel 14, and to any other components housed within the wheel case 12 as may be required. In some examples, the housing 56 is configured so that the lubricating oil collects in a bottom portion of the wheel case 12. An oil level, shown by line OL in FIGS. 3A and 3B, in the wheel case 12 can be maintained at any level that provides sufficient lubricant to wheel case components during use. Lubricating oil can also collect or be retained within a bearing channel 34 including the bearings 28 to an oil level, shown in FIGS. 3A and 3B. As described in greater detail hereinafter, the oil level OL in the bearings 28, after the device 10 stops rotation, can be defined by the lowest of either the dam 110 or a bottom of an aperture 92 extending through the hub 74 of the wheel 14.

During use, portions of the wheel(s) 14, 16, 18 rotate through the lubricating oil collected in the bottom of the wheel case 12. Contact between the wheel(s) 14, 16, 18 and oil agitates the oil, causing the oil to splash upwardly towards components of the wheel case 12 including upper portions of the wheel(s) 14, 16, 18 and the bearings 28. Continued rotation of the wheel(s) 14, 16, 18 distributes the lubricating oil through the wheel case 12 and housing 56. As will be appreciated by those skilled in the art, as a temperature of the lubricating oil increases, which occurs during operation of the vibrating screen device 12, the oil becomes more flowable, meaning that oil splashes more freely. The warmed oil flows through the wheel case 12 more easily, which increases distribution of the oil through the wheel case 12. Therefore, components of the wheel case 12 are lubricated more efficiently after the vibrating screen device 12 has been in use for a period of time.

The devices and wheel case arrangements disclosed herein are intended to ensure that proper distribution of oil occurs shortly after activation of the vibrating screen device 10 and, in particular, to reduce or eliminate a lag time before proper distribution of oil is obtained. In order to quickly provide proper distribution of lubricating oil in the wheel case 12, the wheel case 12 can further include the dam 110 mounted to a side 66 of the wheel 14 arranged to collect the lubricating oil in an interior volume 112 defined by the dam 110 during rotation of the wheel 14. In order to ensure that all bearings 28 receive proper lubrication, each of the six wheels (shown in FIG. 2) of the vibrating screen device 10 can include an oil dam 110 adjacent to the wheel 14, 16, 18. For example, as shown in FIGS. 3A-4B, the oil dam 110 can be positioned on the inwardly facing side 66 of the wheel(s) 14, 16, 18. The collected lubricating oil remains in the volume 112 defined by the dam 110 when rotation of the wheel 14, 16, 18 ceases. Since the dam 110 traps certain amounts of lubricating oil near the bearings 28, the collected lubricating oil in the volume 112 is available to lubricate the wheel(s) 14, 16, 18 and the bearings 28 when rotation of the wheel(s) 14, 16, 18 resumes. For example, rotation of the wheel 14, 16, 18 can cease when the drive motor 44, configured to rotate the shaft(s) 20, 22, 24 of the vibrating screen device 10, is deactivated. Rotation of the wheel(s) 14, 16, 18 can resume upon reactivation of the drive motor 44.

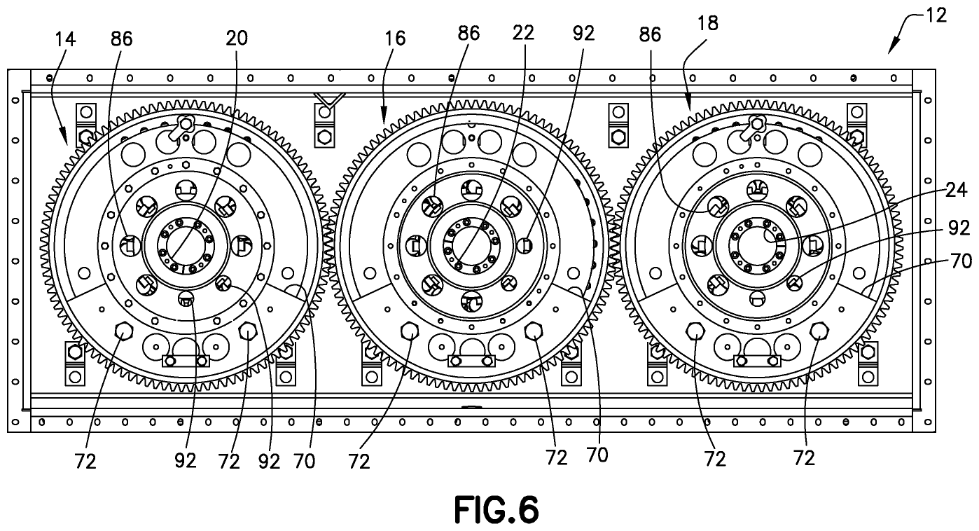

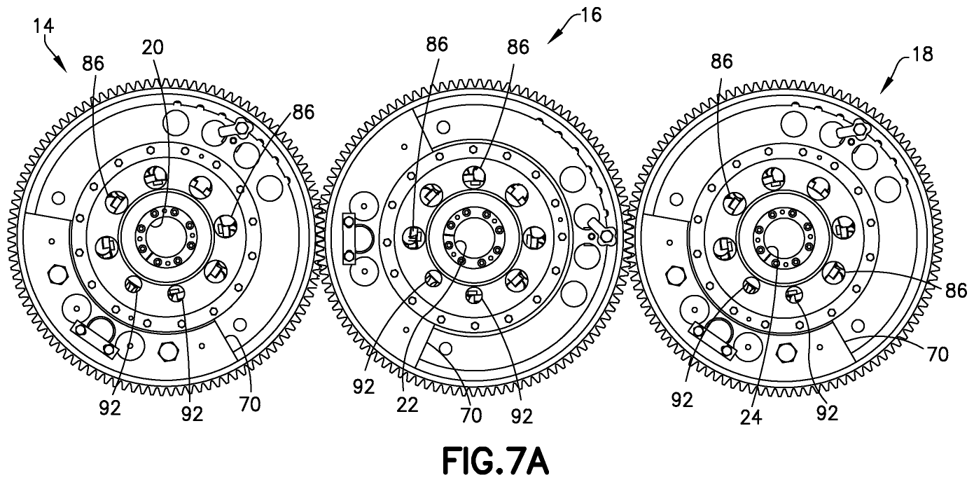

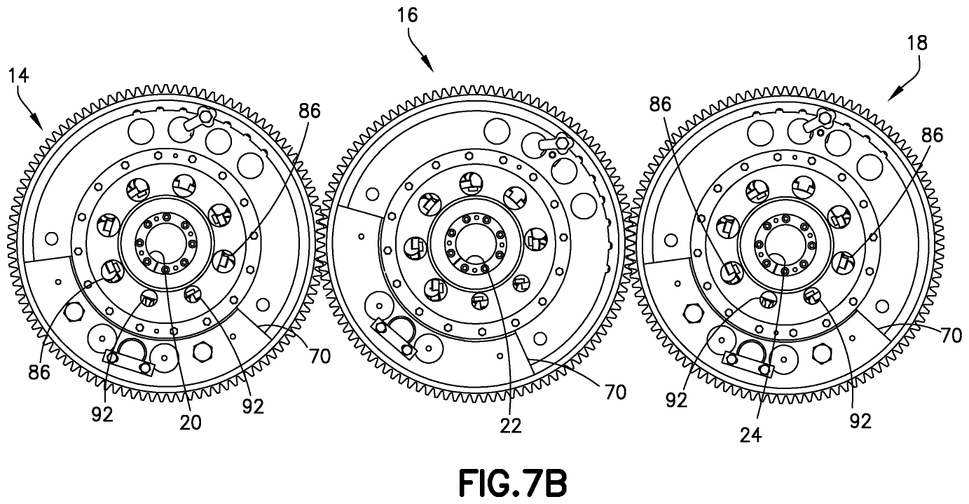

In some examples, the wheel(s) 14, 16, 18 and eccentric weight(s) 70 are arranged such that the wheel(s) 14, 16, 18 come to rest at one of a plurality of predetermined rest or timing positions, when the drive motor 44 is turned off. For example, the wheel(s) 14, 16, 18 can have seven or more timing positions. By way of example, the three wheels 14, 16, 18 are shown in an installation position in FIG. 6. A view of the outwardly facing side 68 of the wheels 14, 16, 18 is shown in FIG. 7A at a rest position with 30° timing. For comparison, FIG. 7B shows the outwardly facing side 68 of the wheels 14, 16, 18 at a rest position with 60° timing. As will be appreciated by those skilled in the art, an angle of the timing position refers to a position during rotation of the wheels 14, 16, 18 when the eccentric weights 70 on a majority of the wheels 14, 16, 18 point in the same direction. The 30° angle is measured relative to a horizontal axis. The wheels 14, 16, 18 can also be adapted to adopt a plurality of other rest positions when rotation of the wheels 14, 16, 18 ceases, such as a 35° timing position, a 40° timing position, a 45° timing position, a 50° timing position, and a 55° timing position. As discussed in further detail herein, the dam 110 can be configured to maintain lubricating oil in proximity to the bearings 28 regardless of which timing or rest position the wheel(s) 14, 16, 18 adopt.

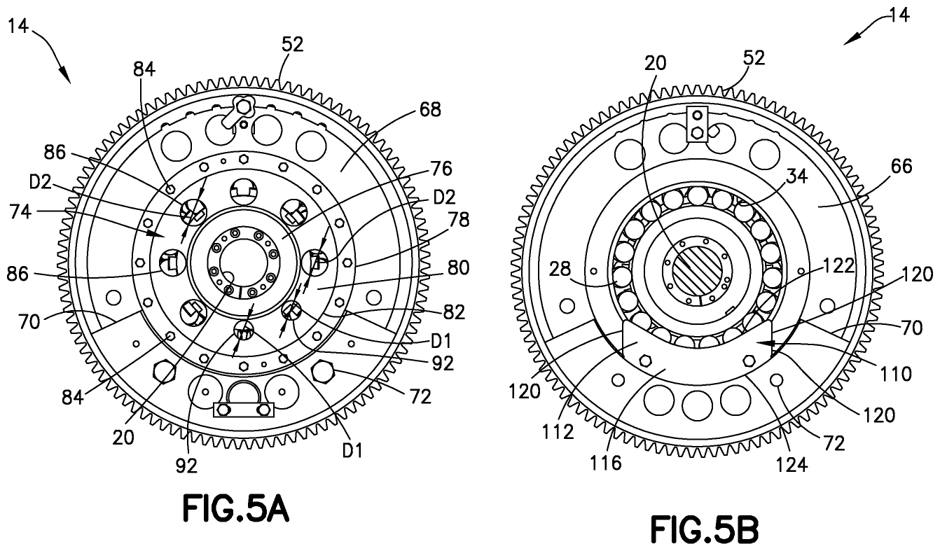

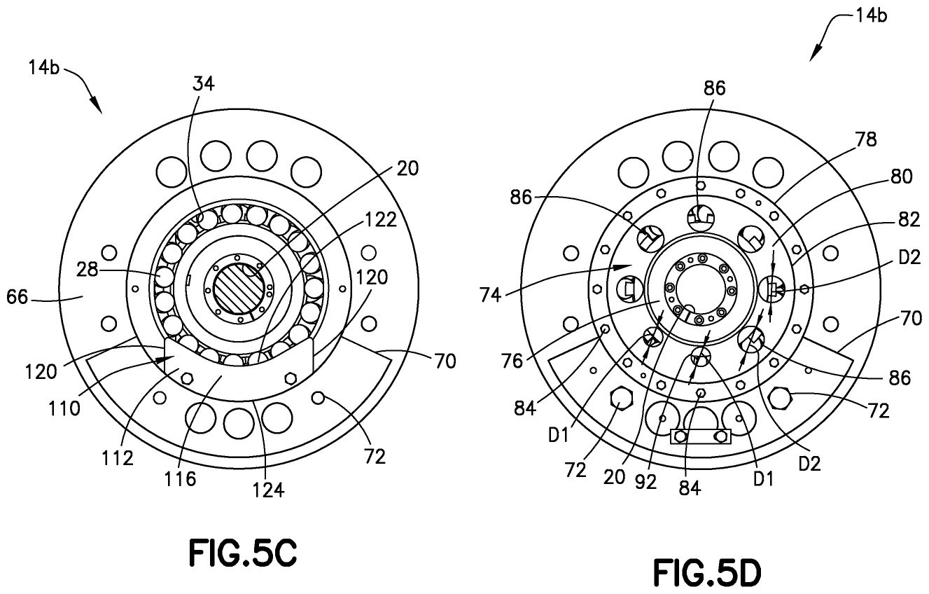

The outwardly facing side 68 and the inwardly facing side 66 of the first wheel 14 are shown in detail in FIGS. 4A, 5A, and 5B. The opposing wheel 14b mounted to the opposing end of the shaft 20 is shown in FIGS. 4B, 5C, and 5D. In many cases, the opposing wheel 14b is substantially similar in size and shape to the first wheel 14. However, opposing wheel 14b does not include gears. Also, while only the first wheel 14 is described in detail herein, it is understood that the other wheels 16, 18 of the wheel case 12 are substantially similar in structure to the first wheel 14.

As shown in FIGS. 3A-5D, the hub 74 of the wheel 14 includes a central portion 76, a peripheral flange 78, a central flat portion 80, and an outer sidewall 82 disposed between the central portion 76 and the peripheral flange 78. The central portion 76 can be fixedly connected or secured to the shaft 20, such that the hub 74, wheel 14, and shaft 20 rotate together about the central axis A2. The peripheral flange 78 of the hub 74 can be connected to other portions of the wheel 14. For example, the peripheral flange 78 can be connected to the wheel 14 by bolts 84. The flat portion 80 of the hub 74 includes a plurality of through holes or apertures 86. The apertures 86 can be spaced circumferentially about the flat portion 80 and radially inwardly from the outer sidewall 82. For example, the hub 74 can include eight or more holes or apertures 86 circumferentially spaced on the flat portion 80 of the hub 74.

A pocket 88 (shown in FIGS. 3A and 3B) is defined in part by cooperating portions of the flat portion 80 and an inner surface 90 of the sidewall 82. The spaced apart holes or apertures 86 are sized and arranged to control flow of lubricating oil through the hub 74 and pocket 88 to the bearings 28 in a direction of the arrow L1 (shown in FIG. 3B). For example, lubricating oil can flow through the apertures 86 and into the pocket 88. A size of the apertures 86 largely determines or controls an amount of lubricating oil that can flow to the bearings 28 as the wheel rotates. Therefore, increasing a total area of the apertures (e.g., by increasing a size or a number of apertures on the flat portion 80) generally increases flow of lubricating oil to the bearings 28. However, aperture size and position also determines or controls how much oil remains in proximity to the bearings 28 when rotation of the wheel 14 ceases. In particular, larger apertures allow more lubricating oil to flow away from the bearings 28 when rotation of the wheel 14 ceases. Therefore, in order to ensure that some lubricating oil remains near the bearings 28, a size of at least some of the apertures is necessarily limited.

A wide variety of different aperture designs can be envisioned within the scope of the present disclosure, taking into account a need to allow oil to flow to the bearings 28 and to maintain oil in proximity the bearings 28 when rotation of the wheel ceases. In some examples, as shown in FIGS. 5A-5D, the hub 74 includes apertures 86 of different sizes. For example, some apertures (referred to herein as damming apertures 92) are smaller in area to trap the lubricating oil near the bearings 28. Other apertures 86 are larger to encourage free flow of lubricating oil into and from the pocket 88 and bearings 28. More specifically, as shown in FIG. 5A, the damming apertures 92, which are positioned opposite to the dam 110, have a smaller area than other apertures 86 of the hub 74. For example, the damming apertures 92 may have a diameter D1 which is about 10%, 20%, or 30% less than a diameter D2 of the other apertures 86. The smaller damming apertures 92 are positioned to trap the lubricating oil in the wheel 14 and bearings 28 when rotation of the wheel 14 ceases. Particularly, it is believed that lubricating oil in the bearing channel 34 and bearings 28 will be restricted from flowing through the bearing channel 34 toward the outwardly facing side of the wheel 14 by the smaller damming apertures 92. Lubricating oil is restricted from flowing away from the bearings 28 and toward the inwardly facing side 66 of the wheel 14 by the dam 110. As discussed previously, the lower of either the dam 110 or bottom of the damming aperture 92 defines the oil level in the bearing channel 34 when rotation of the wheel 14 ceases.

In other examples, the hub 74 could not include any apertures opposite the dam 110, which would mean that the oil level at the bearings 28 when rotation of the wheel 14 ceases would be dependent solely upon a height of the dam 110, since no lubricating oil would flow away from the bearings 28 through the hub 74 (e.g., due to the absence of apertures opposite the dam 110). In still other examples, all of the apertures of the hub 74 could have a smaller area, similar to the area of the damming apertures 92 shown in FIGS. 5A and 5D. Beneficially, if all of the apertures had the same reduced size, operation of the device 10 could be simplified since it would not be necessary to ensure that the wheels 14, 16, 18 come to rest with particular apertures (e.g., the limited number of smaller damming apertures 92) near the bearings 28. Also, the apertures 86 could be provided in a variety of shapes and arrangements within the scope of the present disclosure. For example, some apertures 86 could be elliptical, rectangular, or square. In other examples, apertures could be slots extending across a surface of the hub 74.

In some examples, the dam 110 is formed from a plate 114 comprising an outwardly facing side 118, an inwardly facing side 116, and sidewalls or edges extending between the inwardly facing side 116 and the outwardly facing side 118 thereof. The plate 114 can be mounted to the inwardly facing side 66 of the wheel 14. The plate 114 can have any suitable size sufficient to fit on the wheel 14 without restricting rotation thereof and for maintaining at least a portion of the lubricating oil in proximity to the bearings 28. For example, the plate 114 can be a substantially arcuate shape, in which the plate 114 includes an arcuate inner edge 122 (shown in FIGS. 5A and 5D), an arcuate outer edge 124, and radially extending edges 120. The arcuate outer edge 124 of the plate 114 can be adjacent to the eccentric weight 70 mounted to the wheel 14. In order to maintain a substantial amount of lubricating oil in proximity to the bearings 28, when rotation of the wheel 14 ceases, the plate 114 must block or cover a substantial portion of an opening of the bearing channel 34. For example, as shown in FIG. 3B, the dam 110 may have a height H1, which is at least one half of a height H2 of the bearing channel 34. In other examples, the height H1 of the dam 110 can be 60%, 75%, or 80% of the height H2 of the bearing channel 34.

Operation of the wheel 14 will now be described in detail. Other wheels 14b, 16, 16b, 18, 18b of the wheel case(s) 12 operate in substantially the same manner as wheel 14, as described herein. In operation, in response to the operation of the drive motor 44, the wheel 14 rotates in the direction shown by arrow A in FIG. 1. As the wheel 14 rotates, the eccentric weight 70 travels along the weight path (shown by arrow A in FIG. 1) and the gear teeth 52 of the wheel 14 pass through the oil collected near the base wall 58 of the housing 56. The action of the wheel 14 contacting the oil causes the oil to be thrown toward the upper portions of the housing 56. A portion of the oil flows toward and into the bearing channel 34 to provide lubrication to the bearings 28. Other portions of the upwardly thrown oil splash against the base wall 58, the sidewall 62, and the cover wall 60, and gradually migrate downwardly along the walls 60, 62. The downward migration along the walls 60, 62 acts to cool the oil, which can lessen a need for external oil coolers.

As described previously, the hub 74 rotates in conjunction with the wheel 14. As the oil is thrown upwardly, the apertures 86, 92 provide an oil flow path indicated by the arrow L1 (shown in FIG. 3B) into the bearing channel 34 and bearings 28. Some lubricating oil also collects in the pocket 88. As will be appreciated by those skilled in the art, oil contained in the pocket 88 becomes cylinder shaped as the hub 74 rotates. The apertures 86, 92 are located such that the pocket 88 is in alignment with, or located slightly radially outwardly of, the bearing channel 34. Accordingly, pocket 88 can be arranged to provide a substantially constant supply of additional oil to the bearings 28. Maintaining a substantially constant supply of oil to the bearings 28 prevents overheating, which can occur when oil in the bearings 28 is stagnant. Other portions of the lubricating oil, which are splashed upwardly from the bottom of the wheel case 12 contacts and runs down the interior walls of the housing 56, cooling the oil in the process. The downwardly migrating oil collects in the bottom of the housing 56. The oil level in the bottom of the housing 56 is high enough that an outside diameter of the wheel 56, weights 70, and/or teeth 52 (if present) make contact with the oil.

As shown by arrow L2 (in FIG. 3B), continued rotation of the wheel 14 drives the lubricating oil through the bearing channel 34, past the bearings 28, and toward the dam 110. As discussed previously, a height of the dam 110 can be about one half or more of the height of the bearing channel 34. Accordingly, some portion of the lubricating oil passes over the dam 110 and returns towards the bottom of the housing 56. Other portions of the lubricating oil are trapped in the bearing channel 34 and bearings 28 and/or pass back through the bearing channel 34 towards the pocket 88. Since the lubricating oil does not pass over the dam 110, a portion of lubricating oil remains near the bearings 28 throughout operation of the vibrating screen device 10.

When rotation of the shaft 20 and wheel 14 ceases, the wheel 14 comes to rest at one of the timing positions. For example, the wheel 14 may come to rest at the 30° timing position, as shown in FIG. 7A. Due to the positioning of the dam 110 on the wheel 14, the lubricating oil remains trapped near the bearings 28 with the wheel 14 in the 30° timing position. Since the lubricating oil remains trapped in proximity to the bearings 28, the bearings 28 have sufficient lubrication when the vibrating screen device 10 restarts. As discussed previously, ensuring that the bearings 28 are lubricated during startup of the device 10 prevents damage to rotating components of the vibrating screen device 10 and wheel case 12.

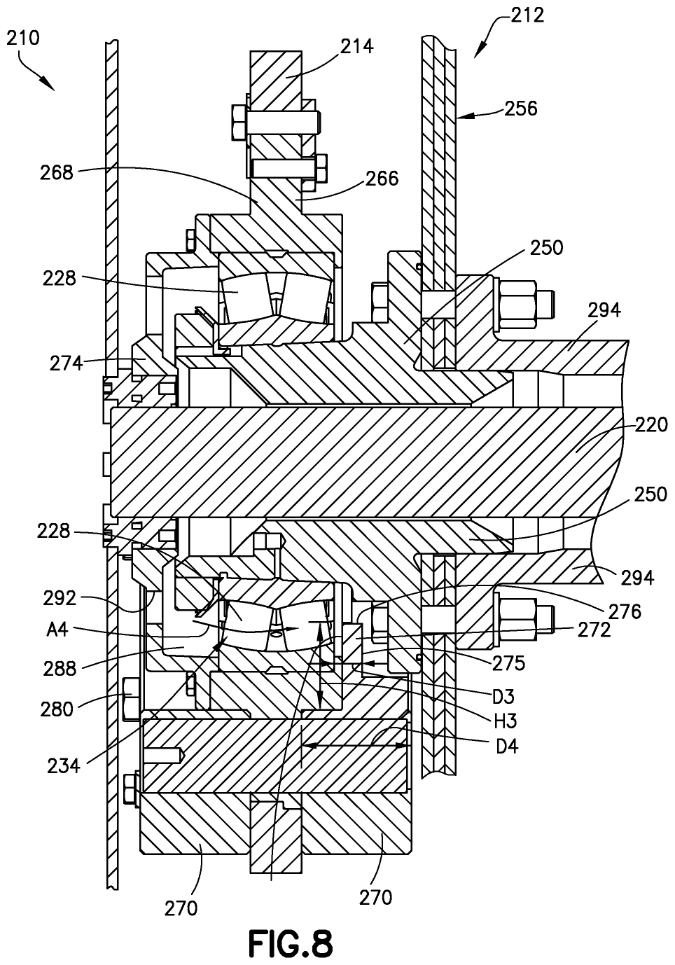

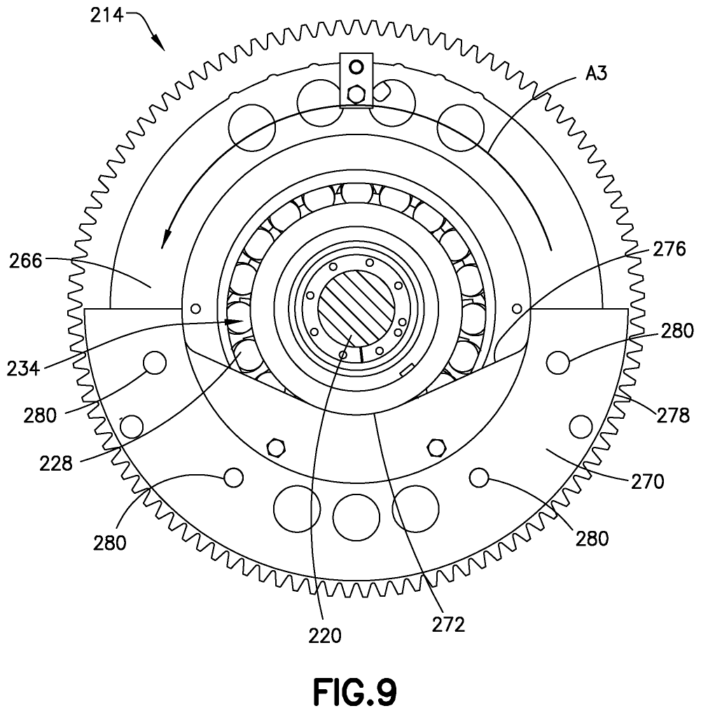

Another exemplary wheel case of a vibrating device 210, such as a vibrating screen, is shown in FIGS. 8 and 9. As in previous examples, the vibrating device 210 includes the rotatable shaft 220 enclosed within a shaft tube 294 extending through the wheel case 212. The wheel case 212 includes the housing 256 configured to contain a quantity of lubricating oil and the wheel 214. As in previous examples, the shaft 220 passes through a central bore of a spindle 250, which is fixedly mounted to the housing 256. The wheel 214 is disposed at least partially within the housing 256 and is connected to the shaft 220 through the hub 274. The wheel 214 rotates about the spindle 250 over the bearings 228. The wheel 214 is arranged such that during rotation of the wheel 214, the lubricating oil is distributed through the housing 256 to lubricate the wheel 214, bearing(s) 228, and/or shaft 220. The wheel 214 also includes the eccentric weight 270 mounted to the inwardly facing side 266 and/or the outwardly facing side 268 of the wheel 214. The eccentric weight 270 is configured to move along a circular path, shown by arrow A3 (shown in FIG. 9), upon rotation of the wheel 214. The wheel case 212 also includes a dam 272. As in previous examples, the dam 272 is configured to collect the lubricating oil during rotation of the wheel 214 so that the collected lubricating oil remains in the volume defined by the dam 272 when rotation of the wheel 214 ceases.

Unlike in previous examples, in which the dam was a separate plate mounted to one of the sides of the wheel, the dam 272 is integrally formed with the eccentric weight 270. In some instances, the integral dam 272 or dam portion of the eccentric weight 270 can be a narrow segment extending radially inwardly from other portions of the eccentric weight 270. For example, the dam 272 can have a thickness D3, which is substantially thinner than a thickness D4 of other portions of the eccentric weight 270. The dam 272 can extend radially inwardly from other portions of the weight 270 a distance or height H3 selected to capture a sufficient amount of lubricating oil in proximity to the bearings 228. In some examples, the dam 272 includes a substantially flat inwardly facing surface 275 positioned to at least partially block the channel 234 containing the bearings 228, as shown in FIG. 8.

A view of the inwardly facing side 266 of the wheel 214 is shown in FIG. 9. The outwardly facing side 268 of the wheel is substantially identical to the outwardly facing side 68 shown in FIG. 5A. As shown in FIG. 9, the dam 272 of the eccentric weight 270 covers a portion of the inwardly facing side 266 of the wheel 214. The eccentric weight 270 is generally a semi-circular shape, with a central portion cutaway to accommodate the spindle 250. The dam 272 defines an arcuate inner edge 276 extending from the outer circumferential edge 278 of the weight 270. The weight 270 can be mounted to the wheel by bolts 280.

As in previous examples, during rotation of the wheel 214, lubricating oil passes from the wheel case 212 into the wheel 214 through apertures on the outwardly facing side 268 of the wheel 214, such as the damming aperture 292 shown in FIG. 8. After passing through the aperture 292, some lubricating oil collects in a pocket space 288 located behind the aperture 292. Some oil passes through the pocket 288 and into the channel 234 to contact the bearings 228, in a direction of arrow A4. As rotation of the wheel 214 continues, oil passes through the channel 234 and over the dam 272 of the eccentric weight 270. When rotation of the wheel 214 ceases, a portion of the lubricating oil remains in the channel 234 and in contact with the bearings 228, since the dam 272 of the eccentric weight 270 captures an amount of lubricating oil within the channel 234. As discussed previously, an oil level in the channel 234 is the lower of a lowest edge of the aperture 292 and the inner edge 276 of the dam 272 of the eccentric weight 270.

While specific examples of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof. Further, although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A wheel case for a vibrating device for vibrating aggregate material, the wheel case comprising:
a housing configured to contain a quantity of lubricating oil;
at least one wheel positioned in the housing and mounted to a shaft of the vibrating device, the at least one wheel comprising: an inwardly facing side; an outwardly facing side; at least one eccentric weight mounted to the inwardly facing side or the outwardly facing side; and a plurality of bearings positioned in an annular bearing channel configured to permit the at least one wheel to rotate about a spindle of the shaft, wherein the at least one wheel is arranged such that during rotation of the at least one wheel, the lubricating oil is distributed through the housing to lubricate the at least one wheel, bearings, and/or shaft; and
a dam mounted on a side of the at least one wheel at least partially covering the annular bearing channel, positioned such that the lubricating oil collects in the annular bearing channel during rotation of the at least one wheel, and such that the collected lubricating oil remains in the annular bearing channel when rotation of the wheel ceases.

2. The wheel case of claim 1, wherein the collected lubricating oil in the annular bearing channel is available to lubricate the at least one wheel and/or the plurality of bearings when rotation of the at least one wheel resumes.

3. The wheel case of claim 2, further comprising an external drive device configured to rotate the at least one shaft of the vibrating device, wherein rotation of the at least one wheel ceases when the external drive device is deactivated, and wherein rotation of the at least one wheel resumes upon reactivation of the external drive device.

4. The wheel case of claim 1, wherein, during rotation of the at least one wheel, at least a portion of an outer diameter of the at least one wheel and/or the at least one eccentric weight contacts a portion of the lubricating oil collected in a bottom portion of the housing, causing the lubricating oil to be distributed through the housing.

5. The wheel case of claim 1, wherein when rotation of the at least one wheel ceases, a level of the lubricating oil in the annular bearing channel is at least partially defined by a height of a portion of the dam covering the annular bearing channel.

6. The wheel case of claim 1, wherein the at least one wheel comprises a hub positioned on the outwardly facing side of the at least one wheel, operatively connecting the at least one shaft to other portions of the at least one wheel, the hub being adapted to distribute the lubricating oil to the plurality of bearings as the at least one wheel rotates about the plurality of bearings.

7. The wheel case of claim 6, wherein the hub comprises at least one aperture extending through the hub, from an outwardly facing side to an inwardly facing side thereof, and wherein the at least one aperture is aligned with the annular bearing channel.

8. The wheel case of claim 6, wherein the hub comprises a plurality of circumferentially positioned apertures extending through the hub, from an outwardly facing side to an inwardly facing side thereof,
wherein the dam is mounted to the inwardly facing side of the at least one wheel opposite at least one of the plurality of apertures of the hub, and
wherein the at least one aperture positioned opposite to the dam has a smaller area than other apertures of the plurality of apertures which are not opposite to the dam.

9. The wheel case of claim 6, wherein the hub comprises a circumferential outer edge and a peripheral sidewall spaced radially inward from the outer edge, and wherein an inwardly facing portion of the sidewall defines an oil receiving pocket aligned with and adapted to distribute the lubricating oil into the annular bearing channel.

10. The wheel case of claim 1, wherein the dam comprises a plate comprising an outwardly facing side and an inwardly facing side, and wherein the outwardly facing side of the plate is mounted to the inwardly facing side of the wheel.

11. The wheel case of claim 10, wherein the plate further comprise an arcuate inner edge, an arcuate outer edge, and radial edges extending therebetween, and
wherein the arcuate inner edge of the plate defines an arc of less than about 120 degrees, such that the plate covers less than about one third of the annular bearing channel.

12. The wheel case of claim 11, wherein the at least one eccentric weight comprises an arcuate plate mounted to the inwardly facing side of the at least one wheel, and
wherein the arcuate outer edge of the plate contacts an edge of the at least one eccentric weight.

13. The wheel case of claim 1, wherein the vibrating device comprises at least a first shaft, a second shaft, and a third shaft, and wherein the wheel case comprises at least a first wheel mounted to the first shaft, a second wheel mounted to the second shaft, and a third wheel mounted to the third shaft.

14. The wheel case of claim 1, wherein the at least one wheel comprises gear teeth extending about a periphery of the at least one wheel arranged to transfer rotation of the at least one wheel to another wheel at least partially enclosed in the wheel case.

15. The wheel case of claim 1, wherein the dam is integrally formed with the at least one eccentric weight.

16. A vibrating device for vibrating aggregate material, the device comprising:
a frame;
at least one rotating shaft rotatably mounted to the frame, the at least one shaft being configured to be rotated by an external drive device; and
a wheel case enclosing at least a portion of the at least one shaft, the wheel case comprising:
a housing configured to contain a quantity of lubricating oil;
at least one wheel positioned in the housing and mounted to the at least one shaft of the vibrating device, the at least one wheel comprising: an inwardly facing side; an outwardly facing side; at least one eccentric weight mounted to the inwardly facing side or the outwardly facing side; and a plurality of bearings positioned in an annular bearing channel configured to permit the at least one wheel to rotate about a spindle of the shaft, wherein the at least one wheel is arranged such that during rotation of the at least one wheel, the lubricating oil is distributed through the housing to lubricate the at least one wheel, bearings, and/or shaft; and
a dam mounted on a side of the at least one wheel at least partially covering the annular bearing channel, positioned such that the lubricating oil collects in the annular bearing channel during rotation of the at least one wheel, and such that the collected lubricating oil remains in the annular bearing channel when rotation of the wheel ceases.

17. The vibrating device of claim 16, wherein the wheel case comprises a first wheel, a second wheel, and a third wheel, and wherein the vibrating device comprises a first shaft mounted to the first wheel, a second shaft mounted to the second wheel, and a third shaft mounted to the third wheel.

18. The vibrating device of claim 17, wherein each of the wheels comprise gear teeth extending about a periphery of the wheels arranged such that rotation of one of the shafts is transferred to each of the wheels through engagement between gear teeth of the wheels.

19. The vibrating device of claim 17, wherein the first, second, and third wheels are configured to come to rest at any of a plurality of timing positions, and wherein the dam of each of the wheels is positioned such that the dam retains lubricating oil in the annular bearing channel of each wheel, when the wheels are in any of the plurality of timing positions.

20. The vibrating device of claim 17, wherein the frame comprises a deck configured to retain a classification screen, and wherein rotation of the at least one shaft and the at least one wheel vibrates the deck and the classification screen retained by the deck
